(19) United States
(12) Patent Application Publication
(10) Pub. No.: US 2004/0087826 A1
(43) Pub. Date: May 6, 2004

(54) Method for treating dioxin contaminated incineration ash

(76) Inventor: Alan B. Cash, San Diego, CA (US)

Correspondence Address: NEIL K. NYDEGGER, NYDEGGER & ASSOCIATES, 348 Olive Street, San Diego, CA, 92103, US

(21) Appl. No.: 10/288,049

(22) Filed: Nov. 4, 2002

(51) Int. Cl. A62D 3/00

(52) U.S. Cl. 588/207

(57) ABSTRACT

A method for reducing the toxicity of incineration ash containing dioxin-type compounds includes the step of contacting the contaminated incineration ash with an aqueous solution of an alkaline earth metal hydroxide. Detoxification occurs at relatively low temperatures (e.g. below 350 degrees Celsius) and can be performed in the presence of water that is often found in incineration ash storage piles. The solution and ash are kept in contact for a pre-determined detoxification period. Once detoxification has progressed to a desired endpoint, the solution is drained to a storage vessel where it can be re-used to treat additional incineration ash. In one implementation, the treatment is performed at a slightly elevated temperature (e.g. 100 degrees Celsius) to reduce the length of the detoxification period while maintaining the same level of detoxification.

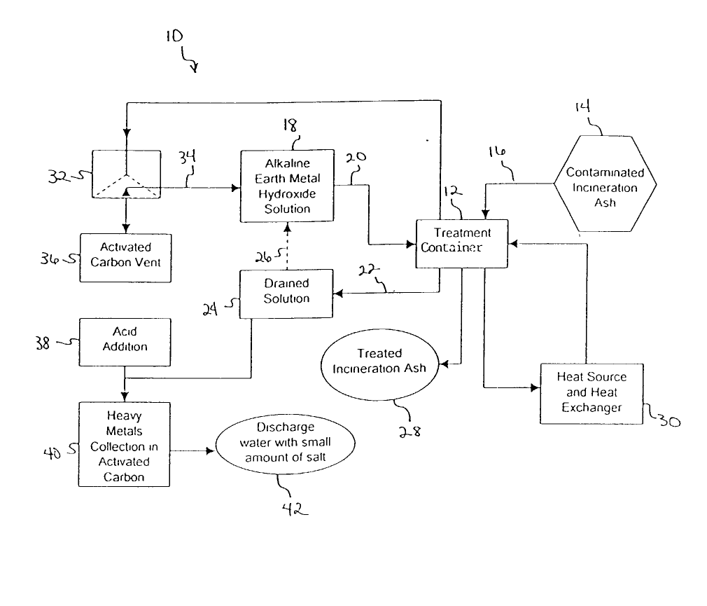

### FIELD OF THE INVENTION

The present invention pertains generally to methods for reducing the toxicity of incineration ash containing dioxin-type compounds. More particularly, the present invention pertains to reducing the toxicity of incineration ash containing dioxin-type compounds in the presence of water at low temperatures. The present invention is particularly, but not exclusively, useful for reducing the toxicity of an incineration ash containing dioxin-type compounds by contacting the ash with a solution comprising water and a hydroxide of an alkaline earth metal.

### BACKGROUND OF THE INVENTION

Since the 1980's, it has been recognized that reducing or eliminating the chlorine content of dioxin-type compounds can lead to a reduction in toxicity. As used herein the term “dioxin-type compounds” includes, but is not limited to: toxic compounds such as polychloro-p-dibenzodioxins (PCDD), polychlorodibenzofurans (PCDF) and polychlorinated biphenyls (PCBs). These dioxin-type compounds are generally found in incineration ash discharged from various incineration plants such as an incineration plant for municipal solid waste, industrial waste and/or medical waste.

Heretofore, methods have been disclosed for reacting alkali metals (such as sodium) with materials containing dioxin-type compounds to reduce the toxicity of the material. Unfortunately, the handling of alkali metals can be very dangerous, and must be done under anhydrous conditions and with inert atmospheres to avoid the risk of explosion. An example of a process using organic solvents and an alkali metal is disclosed in U.S. Pat. No. 4,327,027 to Howard et al. In greater detail, Howard et al. describes a method for chemical detoxification of toxic chlorinated aromatic compounds comprising incubation of such compounds at elevated temperatures with an amount, in excess of stoichiometric, of alkali metal alcoholates of alkanols, alkoxyalkane glycols, alkanepolyols and monoalkyl ethers thereof.

In order to avoid the obvious problems of working with alkali metals, many other processes were developed using either the hydroxide or alcoholate of the alkali metal in an organic solvent. Typically, these processes are done under anhydrous conditions. The use of the organic solvent has several drawbacks. For one, the use of a solvent such as ethylene glycol, alcohol or 2-methoxyethanol substantially increases the cost of treatment. Additionally, solvents are problematic in the treatment of solids because a large portion of the organic solvent stays with the solid, complicating the disposal of the solids. An example of a process using an alkali metal hydroxide with an organic solvent is disclosed in U.S. Pat. No. 5,043,054 to Halpern et al. In greater detail, Halpern et al. teaches the dehalogenation of contaminated waste materials using 2-methoxyethanol with an alkaline earth metal hydroxide at a temperature in the range of 20-135 degrees Celsius. Similarly, U.S. Pat. No. 6,162,958 to Tateishi, et al., relates to a PCB decomposition process using sodium hydroxide with an organic solvent to form sodium carbonate, in water at no less than 350 degrees Celsius.

Also heretofore, processes have been disclosed to degrade dioxin-type compounds by adsorption of the compounds by a carbonate with an alkali component, followed by roasting at 350 degrees Celsius under anhydrous conditions. For example, U.S. Pat. No. 6,072,099 to Tanaka et al. discloses destruction of dioxins-adsorbed carbonaceous adsorbent at 350 degrees Celsius in the presence of an alkali component and oxygen-deficient state. While this process does not require an organic solvent, anhydrous conditions and an oxygen-deficient atmosphere are required. While these requirements may be feasible for the treatment of a contaminated oil, it is very difficult to maintain anhydrous conditions during treatment of an incineration ash. Specifically, the incineration ash is generally wet from water that is sprayed on the ash to prevent the ash from creating a dust. Also, incineration ashes generally absorb moisture from the air.

Many of the processes above require the use of a catalyst. For example, U.S. Pat. No. 5,276,250 to Hagenmaier et al. teaches that incineration ash can be used as a catalyst. Hagenmaier roasts the wastes until the dioxins and dioxin-type compounds are destroyed. Unfortunately, in Hagenmaier's technique the decomposition takes place at elevated temperatures of 150 to 550 degrees Celsius and requires anhydrous conditions.

In summary, all of the aforementioned methods for treating dioxin-type compounds, when used to treat incineration ash have drawbacks. In one set of processes, dangerous alkali metals are used. In another process, the waste must be contacted with a fluid composed of 90% or more of an organic solvent that will increase costs and leave large amounts of residual solvents in the treated incineration ash. In yet another set of processes, the waste must be anhydrous and be heated to relatively high temperatures.

In light of the above, it is an object of the present invention to reduce the toxicity of incineration ash with a simple process that can be done in the presence of water at low temperatures. It is another object of the present invention to treat incineration ash without leaving the treated incineration ash contaminated with large amounts of residual solvents introduced during treatment. Yet another object of the present invention is to provide a method for treating incineration ash which is easy to use, relatively simple to manufacture, and comparatively cost effective.

### SUMMARY OF THE INVENTION

The present invention is directed to a method for reducing the toxicity of incineration ash containing dioxin-type compounds. The method of the present invention is performed at low temperatures (e.g. below 350 degrees Celsius) and can be performed in the presence of water that is often found in incineration ash storage piles.

In accordance with the present invention, a treating solution of water and alkaline earth metal hydroxide such as sodium hydroxide or potassium hydroxide is brought into contact with contaminated incineration ash. In one implementation, the ash is placed in a container and is totally immersed in the solution to assure complete contact of the ash with the treating solution. The solution and ash are kept in contact for a pre-determined detoxification period. Once detoxification is completed, the solution is drained to a storage vessel. Solution drained from the incineration ash can be re-used to treat additional incineration ash. Prior to reuse, the pH of the solution is monitored to assure that pH levels have not dropped below a pH of 9.

In one implementation of the present invention, the treatment is performed at slightly elevated temperatures (e.g. 100 degrees Celsius) to reduce the length of the detoxification period while maintaining the same level of detoxification. The elevated temperature can be maintained by circulating the solution through a heat exchanger and the incineration ash container. Alternatively, the incineration ash/solution slurry can be heated indirectly, for example using a non-contact oil bath. In still another implementation, steam can be injected into the incineration ash container to maintain the slurry at the desired temperature. High temperatures (i.e. greater than 350 degrees Celsius) are not required to achieve detoxification because compounds in the incineration ash act as catalysts allowing the detoxification reaction to occur at the lower temperatures.

After the solution is drained from the incineration ash, the detoxified ash is removed from the container for disposal or in some cases constructive use. If necessary, the pH of the treated incineration ash be reduced prior to final use or disposal by contacting the incineration ash with a solution of water and an acid such as hydrochloric acid.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

The figure is a schematic diagram illustrating the methods of the present invention.

### DESCRIPTION OF THE PREFERRED EMBODIMENTS

With reference now to the Figure, a process is schematically illustrated for treating incineration ash that is contaminated dioxin-type compounds and generally designated 10. As shown, portions of the process 10 are performed in a treatment container 12 that can be either a stationary container such as a holding tank or a mobile container such as a roll-off. When a mobile container such as a roll-off is used, treated incineration ash can be transported in the mobile container to a disposal or reuse facility minimizing material handling costs.

As further shown, incineration ash 14 that is contaminated with dioxin-type compounds that are in excess or are assumed to be in excess of safe levels for direct disposal are introduced into the treatment container 12 (arrow 16). Prior to introduction into the treatment container 12, the incineration ash 14 is generally held in tanks, roll-offs or piles and may contain moisture absorbed from the air or may be wet from dust minimization operations. Suitable incineration ash for treatment by the process 10 includes, but is not limited to, fly ash and other incineration ash from incineration plants that incinerate wastes to include municipal solid waste, industrial waste and/or medical waste.

As further shown, aqueous solution of an alkaline earth metal hydroxide 18 is pumped or fed (arrow 20) into the treatment container 12 sufficient to completely immerse the contaminated incineration ash 14 in solution 18. In one implementation, the solution 18 is circulated through the contaminated incineration ash 14. Suitable alkaline earth metal hydroxides include but are not limited to sodium hydroxide (NaOH) and potassium hydroxide (KOH). A preferable alkaline earth metal hydroxide is sodium hydroxide (NaOH) due to its low cost and worldwide availability. Typically, the alkaline earth metal hydroxide molarity will be in a range from approximately 0.5 moles per liter to approximately 3.0 moles per liter. Immersion of the contaminated incineration ash 14 in the solution 18 assures contact between all portions of the contaminated incineration ash 14 and the solution 18.

In accordance with the methods of the present invention, the solution 18 is left in contact with the contaminated incineration ash 14 for a time period sufficient to reduce the toxicity of contaminated incineration ash 14 to a sufficient level wherein the ash 14 is considered to be safe enough for disposal or constructive use. In many parts of the world, this level is regulated. For example, currently in Japan, the level of dioxin-type compounds must be below 3 ng/g toxicity equivalent to 2,3,7,8 tetrachlorodibenzo-p-dioxin for landfill disposal.

The length of the contact time period can be determined by conducting treatability studies on representative samples of the contaminated incineration ash 14 or by direct measurement of the contaminated incineration ash 14. However, direct measurement is typically expensive and time consuming. Typical contact time periods are in the range of approximately 10 minutes to approximately 2 days. Measurement of the levels of dioxin-type compounds can be performed using standard dioxin test methods that include, but are not limited to, spectroscopic analysis and bio-assays.

After the completion of the prescribed contact time period, the solution 18 is drained (arrow 22) or decanted from the treatment container 12 to a holding tank 24. Because of the alkaline nature of the solution 18, the solution 18 separates easily from the incineration ash 14. In one implementation, the treatment container 12 is prepared with a false bottom to facilitate draining of the solution 18. A filter sheet (not shown) can be used to prevent the incineration ash 14 from entering the false bottom. On the other hand, the solution 18 drains through the filter sheet and collects in the false bottom where it can be subsequently drained to the holding tank 24. Other techniques known in the pertinent art for separating a solid from a liquid such as a filter press could also be used to separate the solution 18 from the incineration ash 14.

Once drained, the used solution 18 in the holding tank 24 can be reused (arrow 26) to treat additional incineration ash 14. The used solution 18 can be mixed with unused solution 18 to obtain the desired concentration (i.e. molarity) of alkaline earth metal hydroxide. As shown in the Figure, treated incineration ash 28 can be disposed of or recycled as a useful product. If a roll-off is used as the treatment container 12, the roll-off can be loaded on to a truck and taken to the desired destination inexpensively and with little additional material handling.

As further shown in the Figure, a heat source and heat exchanger 30 can be used to maintain the solution 18 at a desired, elevated temperature during treatment. Specifically, solution 18 can be circulated through the treatment container 12 and heat exchanger 30. The solution 18 can be circulated through the treatment container 12 from the top to bottom or in the reverse direction. Alternatively, the slurry of incineration ash 14 and solution 18 in the treatment container 12 can be heated indirectly, for example using a non-contact oil bath. In still another implementation, steam can be injected into the treatment container 12 to maintain the slurry at the desired temperature. In one implementation, treatment is conducted at a temperature between 80 to 120 degrees Celsius and at ambient pressure. Mild heating is inexpensive and decreases the required treatment time as compared to a treatment at ambient temperatures.

To prevent the release of unpleasant odors and potentially hazardous contaminants into the air during heating of the incineration ash 14, a small condensation unit 32 can be used to capture vapors and condense them. If desired, the condensed vapors can be reintroduced (arrow 34) to the solution 18. As shown, an activated carbon vent 36 can be used to trap non-condensed vapors. The vent 36 allows an ambient pressure to be maintained during treatment. Additionally, the vent 36 prevents vapor lock from occurring in the treatment container 12 during draining of solution 18 from the treatment container 12.

In some cases, the drained solution 18 in the holding container 24 will contain metal ions leached from the incineration ash 14. As shown an acid solution 38 can be added to the drained solution 18 to cause the metals to precipitate from the solution 18. In one implementation, hydrochloric acid (HCl) is used to precipitate metals due to its availability and cost. After precipitation, the metals can be separated from the solution 18 using activated carbon filtration 40. The carbon collects the metals efficiently but must be periodically replaced. In some cases the metals can be recovered from the spent carbon for re-use. Other separation techniques such as settling, centrifuges or filtering with a filter press can be used to remove the metal precipitates from the solution 18. Also, the addition of acid to the drained solution 18 will de-emulsify any oils which can then be separated from the solution 18 using skimming or decanting techniques. In another implementation, metals ions can be removed directly from the solution 18 (i.e. without acid addition) using an electrolytic process. After the removal of the heavy metals and oil, the remaining solution 42, which essentially consists of water and salts, can be discharged to sewer. In some cases, when the salt content is low, alkaline earth metal hydroxide can be recovered from the remaining solution 42 for treatment of additional incineration ash 14.

Optionally, small amounts of water soluble, organic solvents, up to approximately 50 percent by volume, can be added to the solution 18. Alcohol and Dimethyl Sulfoxide are excellent additives because of their commercial availability, cost and low toxicity. Small, residual amounts of these solvents can be present in the treated incineration ash 28 without complicating disposal of the treated incineration ash 28.

### EXAMPLES

Incineration ash from three separate facilities located in Japan was treated using the methods of the present invention. These samples were subjected to dioxin detoxification treatment by adding between 1 to 3 molar solutions of NaOH or KOH to the fly ash and heating the samples to 100 degrees Celsius in a temperature controlled non-contact oil bath. The samples were heated for periods ranging from 30 minutes to 24 hours. After heat treating, the solution was decanted from the incineration ash, and both the incineration ash and liquids were sampled.

Contact times as short as 20 minutes gave a surprisingly high reduction in dioxin TEQ of 64%. The highest reduction was achieved using a contact time of 24 hours and a solution of potassium hydroxide. This mixture and treatment time reduced Toxicity Equivalent (TEQ) in the highest dioxin incineration ash sample from 1.1 ng/g to 0.01 ng/g, a reduction of 92%. The results of the dioxin detoxification studies are seen in the table below:

| | TEQ | | | TEQ | |
|---|---|---|---|---|---|
| | Initial | TEQ | | Dioxin in | |
| | Value of | Treated | | Drained | |
| Dioxin | Ash | Value of | % | Solution | |
| Detoxification | (ng/g) | Ash (ng/g) | Reduction | (ng/g) | Notes |
| Plant 1 | 1.09 +/− 0.06 | 0.33 +/− 0.04 | 69.72% | Non- | Heated 4 |
| Baghouse | | | | detect | hours in 1 |
| Ash | | | | | molar |
| | | | | | NaOH |
| | | | | | solution |
| Plant 1 | 1.10 +/− 0.16 | 0.20 +/− 0.02 | 81.8% | 0.0018 | Heated 24 |
| Baghouse | | | | | hours in a |
| Ash | | | | | 3 molar |
| | | | | | NaOH |
| | | | | | solution |
| Plant 1 | 1.10 +/− 0.16 | 0.09 +/− 0.01 | 91.8% | Non- | Heated 24 |
| Baghouse | | | | detect | hours in a |
| Ash | | | | | 3 molar |
| | | | | | KOH |
| | | | | | solution |
| Plant 2 | 0.009 +/− 0.001 | 0.005 +/− 0.001 | 44.44% | Non- | Heated 4 |
| Baghouse | | | | detect | hours in 1 |
| Ash | | | | | molar |
| | | | | | NaOH |
| | | | | | solution |
| Plant 3 | 13.31 +/− 1.26 | 3.81 +/− 0.12 | 71.37% | 0.008 +/− 0.0001 | Heated 4 |
| Cyclone Ash | | | | | hours in 1 |
| | | | | | molar |
| | | | | | NaOH |
| | | | | | solution |
| Plant 3 | 8.807 +/− 0.676 | 3.108 +/− 0.753 | 64.71% | 0.00068 +/− 0.00024 | Heated 30 |
| Cyclone Ash | | | | | minutes in |
| | | | | | 1 molar |
| | | | | | NaOH |
| | | | | | solution |
| Plant 3 | 8.807 +/− 0.676 | 2.21 +/− 0.32 | 74.91% | 0.003 | Heated 20 |
| Cyclone Ash | | | | | hours in |
| | | | | | NaOH |
| | | | | | solution |
| | | | | | with IPA |
| | | | | | and |
| | | | | | DMSO |
| | | | | | additives |

In all samples the dioxin TEQ was significantly reduced.

While the particular methods for treating dioxin contaminated incineration ash as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A method for reducing the toxicity of an incineration ash containing dioxin-type compounds, said method comprising the steps of:
providing a solution comprising water and at least one alkaline earth metal hydroxide; and
contacting the incineration ash with said solution at a temperature below 350 degrees Celsius to reduce the toxicity of the incineration ash.

2. A method for reducing the toxicity of an incineration ash as recited in claim 1 wherein said alkaline earth metal hydroxide is selected from the group consisting of potassium hydroxide, sodium hydroxide and combinations thereof.

3. A method for reducing the toxicity of an incineration ash as recited in claim 1 wherein said contacting step is performed at a temperature between approximately 80 degrees Celsius and 120 degrees Celsius.

4. A method for reducing the toxicity of an incineration ash as recited in claim 1 wherein said solution has an alkaline earth metal hydroxide molarity in a range from approximately 0.5 moles per liter to approximately 3.0 moles per liter.

5. A method for reducing the toxicity of an incineration ash as recited in claim 1 wherein said contacting step is performed for a time period in the range of approximately 10 minutes to approximately 2 days.

6. A method for reducing the toxicity of an incineration ash as recited in claim 1 further comprising the step of:
draining said solution from the incineration ash after said contacting step.

7. A method for reducing the toxicity of an incineration ash as recited in claim 6 further comprising the step of:
heating said drained solution.

8. A method for reducing the toxicity of an incineration ash as recited in claim 7 further comprising the step of:
re-contacting the incineration ash with said solution after heating said drained solution.

9. A method for reducing the toxicity of an incineration ash as recited in claim 6 further comprising the steps of:
mixing said drained solution with an acid to reduce the pH of said solution and form a precipitate; and
filtering said precipitate from said solution using an activated carbon filter.

10. A method for reducing the toxicity of an incineration ash as recited in claim 6 further comprising the steps of:
mixing said drained solution with an acid to reduce the pH of said solution and de-emulsify oil in said solution; and
decanting said oil from the remainder of said solution.

11. A method for reducing the toxicity of an incineration ash as recited in claim 1 wherein said solution further comprises an alcohol.

12. A method for reducing the toxicity of an incineration ash as recited in claim 11 wherein said alcohol constitutes less than 50% by volume of said solution.

13. A method for reducing the toxicity of an incineration ash as recited in claim 1 wherein said solution further comprises a dimethyl sulfoxide.

14. A method for reducing the toxicity of an incineration ash as recited in claim 13 wherein said dimethyl sulfoxide constitutes less than 50% by volume of said solution.

15. A method for reducing the toxicity of an incineration ash as recited in claim 1 wherein the incineration ash is contacted with said solution to reduce the toxicity of the incineration ash to a level below 3 ng/g toxicity equivalent to 2,3,7,8 tetrachlorodibenzo-p-dioxin.

16. A method for reducing the toxicity of an incineration ash as recited in claim 1 wherein said contacting step is accomplished by immersing the incineration ash in said solution.

17. A method for reducing the toxicity of an incineration ash, said method comprising the steps of:
providing a solution comprising water and at least one alkaline earth metal hydroxide;
contacting the incineration ash with said solution at a temperature below 350 degrees Celsius to react dioxin-type compounds in the incineration ash with said solution and create a liquid containing metal ions from the incineration ash; and
separating said liquid from the incineration ash.

18. A method as recited in claim 17 further comprising the steps of:
mixing said liquid with an acid to reduce the pH of the liquid and create a metal precipitate; and
separating said precipitate from said liquid using an activated carbon filter.

19. A method as recited in claim 17 further comprising the steps of:
mixing said liquid with an acid to reduce the pH of the liquid and create a metal precipitate; and
decanting said liquid from said precipitate.

20. A method as recited in claim 17 further comprising the step of:
removing said metal ions from said liquid using electrolysis.

21. A method for reducing the toxicity of an incineration ash containing dioxin-type compounds, said method comprising the steps of:
heating a solution comprising water and at least one alkaline earth metal hydroxide to a temperature between approximately 80 degrees Celsius and 120 degrees Celsius;
immersing the incineration ash in said solution to contact the incineration ash with said solution; and
draining said solution from the incineration ash.
